(19) United States
(12) Patent Application Publication
(10) Pub. No.: US 2013/0110014 A1
(43) Pub. Date: May 2, 2013

(54) DEVICE AND METHOD FOR LIP PLUMPING

(71) Applicants: Josef Luzon, Bet Yehoshua (IL); Martin Gurovich, Tel Aviv (IL)

(72) Inventors: Josef Luzon, Bet Yehoshua (IL); Martin Gurovich, Tel Aviv (IL)

(21) Appl. No.: 13/609,374

(22) Filed: Sep. 11, 2012

Related U.S. Application Data
(60) Provisional application No. 61/553,963, filed on Nov. 1, 2011.

(51) Int. Cl. A61H 7/00

(52) U.S. Cl. 601/6

(57) ABSTRACT

A lip plumping device may include a vacuum applicator configured to fully or partially cover and apply vacuum to a lip or lips of a user, and a controller for controlling operation of the vacuum applicator.

### CROSS REFERENCE TO RELATED APPLICATIONS

The present invention claims the priority benefit of U.S. provisional patent application No. 61/553,963 filed on Nov. 1, 2011, which is incorporated in its entirety herein by reference.

### FIELD OF THE INVENTION

The present invention relates to devices and methods for lip plumping.

### BACKGROUND OF THE INVENTION

To-date, a variety of cosmetics products exists, either designed for lip plumping only or for lip plumping and lip gloss application.

Lip plumping products are aimed at producing puffier lips, which are thought by many as more appealing and desired.

Lip plumping products are typically configured to irritate the thin delicate skin of the lips by exposing the lips to irritating agents, such as, for example, cinnamon, ginger mint, wintergreen or capcicum (the fiery compound found in hot peppers).

Additionally, mechanical manual vacuum-based lip plumping devices are also offered for the same purpose.

The present invention is aimed at provided a method and device to improve lips' skin appearance using a mild treatment preferably with no damage to the skin. In some embodiments of the invention no irritation to the skin is present. The method and device according to embodiments of the present invention are aimed at eliminating or at least greatly minimizing patient discomfort.

### SUMMARY OF THE INVENTION

A lip plumping device according to embodiments of the present invention may include a vacuum applicator configured to fully or partially cover and apply vacuum to a lip or lips of a user. The device may also include a controller for controlling operation of the vacuum applicator.

According to some embodiments of the present invention, the device may include an electrical vacuum pump for generating the vacuum.

According to some embodiments of the present invention, the controller may be configured to sense a current or power consumption of the vacuum pump and to disconnect or reduce the power of the pump when a vacuum level generated by the pump exceeds a safety threshold.

In some embodiments of the present invention the device may include a bore configured to allow holding a finger over the bore to maintain operation of the vacuum applicator and releasing the vacuum by removing the finger from the bore.

In some embodiments of the present invention the device may also include a lip surface covered with exfoliating material for applying on the lip or lips of the user.

According to some embodiments of the invention, the lip plumping device may be configured to apply a cosmetic material on the lip or lips of the user. The cosmetic material may be selected from the group of cosmetic materials consisting of a therapeutic cream and lip gloss.

According to embodiments of the invention, the vacuum applicator may include a plurality of nozzles configured to introduce the exfoliating material.

In some embodiments the device may include a power source.

According to some embodiments of the invention the vacuum applicator may include an elongated aperture through which the vacuum is applied on the lip or lips.

In some embodiments the aperture may be oval or circular.

In some embodiments of the present invention the vacuum applicator may include a plurality of nozzles through which the vacuum is applied on the lip or lips.

In some embodiments the device may include a pressure relief valve.

In accordance with some embodiments of the present invention, there is provided a method for lip plumping. The method may include fully or partially covering a lip or lips of a user by a vacuum applicator and applying vacuum to a lip or lips of a user using the vacuum applicator. The method may also include controlling operation of the vacuum applicator using a controller.

According to some embodiments of the present invention, the method may also include comprising generating the vacuum by an electrical vacuum pump.

In some embodiments of the invention the method may further include holding a finger over a bore to maintain operation of the vacuum applicator and releasing the vacuum by removing the finger from the bore.

In some embodiments the method may further include concurrently exfoliating the lip or lips using exfoliating material covering a surface of the vacuum applicator.

According to embodiments of the invention the method may also include applying a cosmetic material on the lip or lips of the user using the device.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic illustration of a lip plumping device in accordance with an embodiment of the present invention;

FIG. 2 illustrates internal components of a lip plumping device shown in FIG. 1 according to embodiments of the invention;

FIG. 3 illustrates a view of a lip plumping device from a different perspective that the perspective of FIG. 1; and

FIG. 4 illustrates the front end of vacuum applicator 104 a lip plumping device 100, according to another embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, may refer, inter-alia, to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

In accordance with embodiments of the present invention, a lip plumping device and a method thereof are introduced. An aspect of the present invention relates to the use of a vacuum applicator, which is designed to partially or to fully cover a human lip or lips, and apply vacuum forces on that lip or lips. “Vacuum” or “negative pressure” in the context of the present invention is understood to refer to a pressure level or range of pressure levels below the ambient pressure (e.g. sub-atmospheric pressure). In some embodiments, the vacuum generated by a lip plumping device would reach some minus 300-500 millibars. In some embodiments of the lip plumping device, the vacuum generated by the device would be in the range of minus 350-450 millibars. For many purposes using such operating range may facilitate miniaturization of the device, providing a device which is sized to be hand-held.

When applying vacuum forces on the lip or lips, using a lip plumping device, in accordance with an embodiment of the present invention, the lip experiences light pinching that enhances blood flow in the affected area, causing some swelling of the lip or lips. It is also claimed that such activity may also stimulate production of collagen and moisturizing of the lip. The enhanced blood flow within the lips also emphasizes the reddish appearance of the lips.

In some embodiments of the present invention a failsafe control is provided to limit the operation of the vacuum applicator. The vacuum applicator may be limited in various ways. For example, the operating time of the vacuum applicator may be limited. In some embodiments, the vacuum applicator may be operated intermittently. In some embodiments the vacuum level applied may be limited.

In some embodiments a failsafe mechanism of the lip plumping device may be include a controller that senses the current or power consumption of the vacuum pump, the current or current consumption indirectly indicating the level of vacuum being produced by the pump. The controller may be configured to disconnect or reduce the power of the pump when the vacuum pressure level generated by the pump exceeds a safety threshold. In some embodiments of the invention another failsafe mechanism may be employed, using bore located on the housing of the device at a convenient position that allows a user to place a finger over that bore. The finger-covered bore serves as relief valve, leading into a vacuum-prevailing space within the device. When the user removes the finger from the bore (e.g. when the user feels discomfort) the vacuum-prevailing space within the device is breached and the pressure within the device immediately rises to equal to the ambient pressure.

A lip plumping device according to embodiments of the present invention may support simpler, faster and more comfortable usage, and thus may enable new treatments. A lip plumping device according to embodiments of the present invention may vary in size.

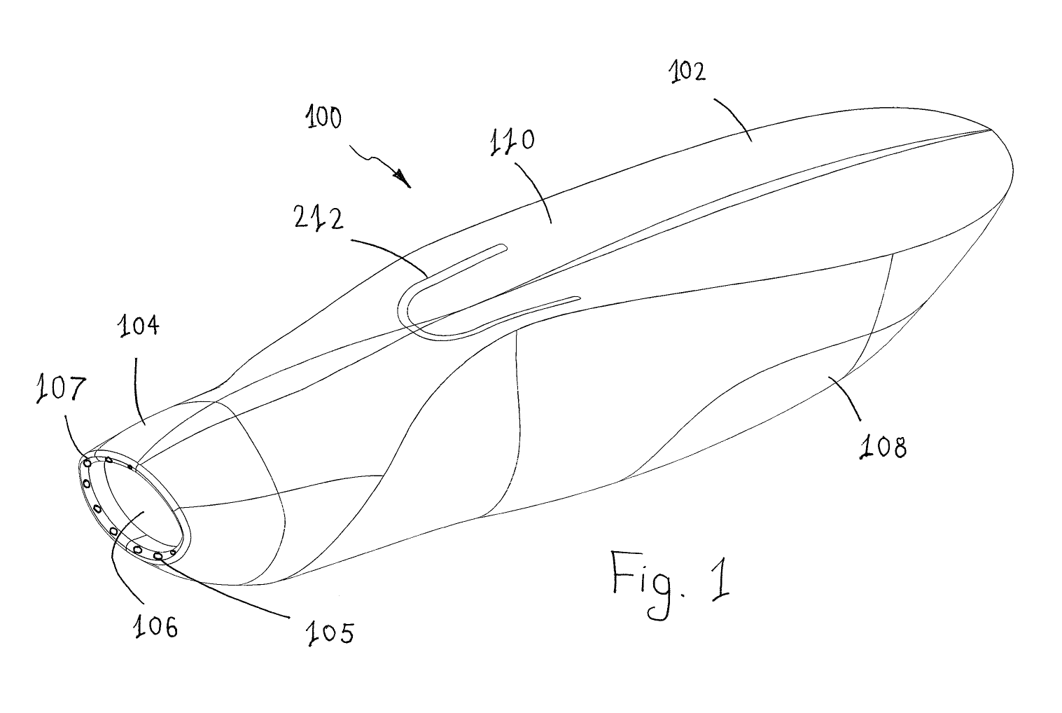

Reference is now made to FIG. 1, which is a schematic illustration of a lip plumping device 100 according to embodiments of the present invention.

Lip plumping device 100 may comprise a body 102, serving as a housing for the internal components of the device. In some embodiments of the invention, body 102 of the lip plumping device would be in an elongated form and sized to comfortably fit a user's hand. A vacuum applicator end 104 would be designed to present an aperture 106, sized to fully or partially cover and apply vacuum to a lip or lips of the user.

Aperture 106 may be circular, oval, or in any other shape. Having an oval shape allows aperture 106 to fully or partially cover a human lip or lips.

A switch 212 may be provided on body 102, to allow the user to switch the device on and off. In some embodiments switch 212 would be depressed once to switch the device on and depressed again to switch the device off. In another embodiment, the device would only work when the switch is depressed, and when it is released the device would go off. Switch 212 may be positioned at a position that would make it easy and simple for the user to hold the device in her or his palm and place a finger over the switch to operate it. In some embodiments body 102 would have a generally rounded surface 108 to match a human hand-grip, complemented with a generally flat-surface 110, on which switch 212 may lie, to allow convenient operation of the switch by the user's finger.

In some embodiments the vacuum pressure of the lip plumping device may be tunable. For example, switch may be a pressure sensitive switch coupled with a controller that is configured to increase or decrease the vacuum level based on the pressure exerted by the finger of the user over the switch, e.g. the greater the pressure on the switch the lower the vacuum level, and vice versa.

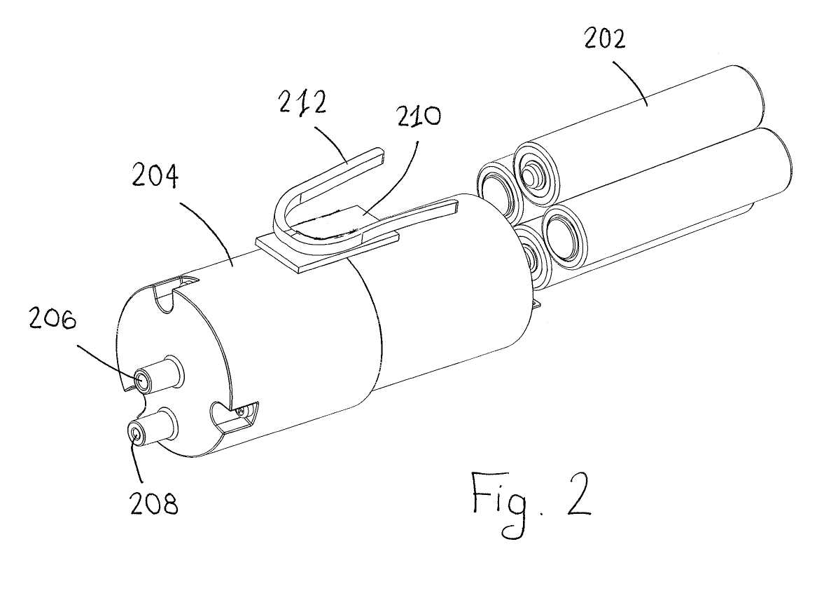

FIG. 2 illustrates internal components of a lip plumping device shown in FIG. 1, according to embodiments of the invention. The device may include an electrically powered vacuum pump 204, which is used to generate vacuum forces at aperture 106 of the lip plumping device (see FIG. 1). Vacuum pump 204 may include inlet 206 for pumping air into the pump, and a pressure relief valve 208 for controlled release of air from the vacuum pump 204, when it is so desired or when a vacuum threshold is reached. The lip plumping device may also include internal power source 202 (e.g. replaceable and/or rechargeable batteries). Alternatively or additionally the device may include a socket for connecting to an external power source (e.g. an AC/DC converter). Controller 210 (e.g. printer circuit board) may be provided to control the operation of the device. Switch 212 may be located over controller 210 so as to allow a user to switch the device on and off.

In some embodiments, pneumatic interconnections between the vacuum pump 204 and the vacuum applicator 104 (more specifically with its aperture 106) may be physically embedded and/or integrated in the lip plumping device 100.

Applicator 104 may be placed on a treated area of the lip or lips and cover it. Applicator 104 may be subjected to user controllable and tunable vacuum negative pressure, which is known to cause skin appearance improvement by enhancing local blood circulation and increasing collagen formation for smoother, more youthful and larger lips.

A lip plumping device, according to embodiments of the present invention may incorporate an exfoliation applicator, or any other type of applicator together with a vacuum applicator. Any such combination of modalities is possible, in accordance with embodiments of the present invention. Which allow two or more different applicators to operate concurrently at the same treated area, either simultaneously or in a predetermined sequence. In some embodiments of the present invention a lip plumping device with additional one or more modalities may include one or more applicators of cosmetic material such as, for example, a therapeutic cream, lip gloss, etc.

Vacuum pump 204 may be, in various embodiments of the present invention, implemented in a variety of technologies, sizes and performances. For example, in some embodiments of the invention vacuum pump 101 204 comprise a vacuum pump only, vacuum and pressure pump, diaphragm pump, piston pump, venture pump, etc. with or without a combination of air valves or switches. In some other embodiments, negative vacuum pressure may be achieved by any other suction mechanism. Vacuum pump 204 may be linked to aperture 106 via a sealed conduit.

Vacuum pressure and/or activation may be controlled and tuned by controller 210, which may include, for example, electrical or electronic control, air flow control, pressure control, mechanical control or a combination thereof. Controller 210 may allow different operation modes, such as continuous vacuum, pulsed or on-demand vacuum, e.g, for example, by pressing and releasing a button.

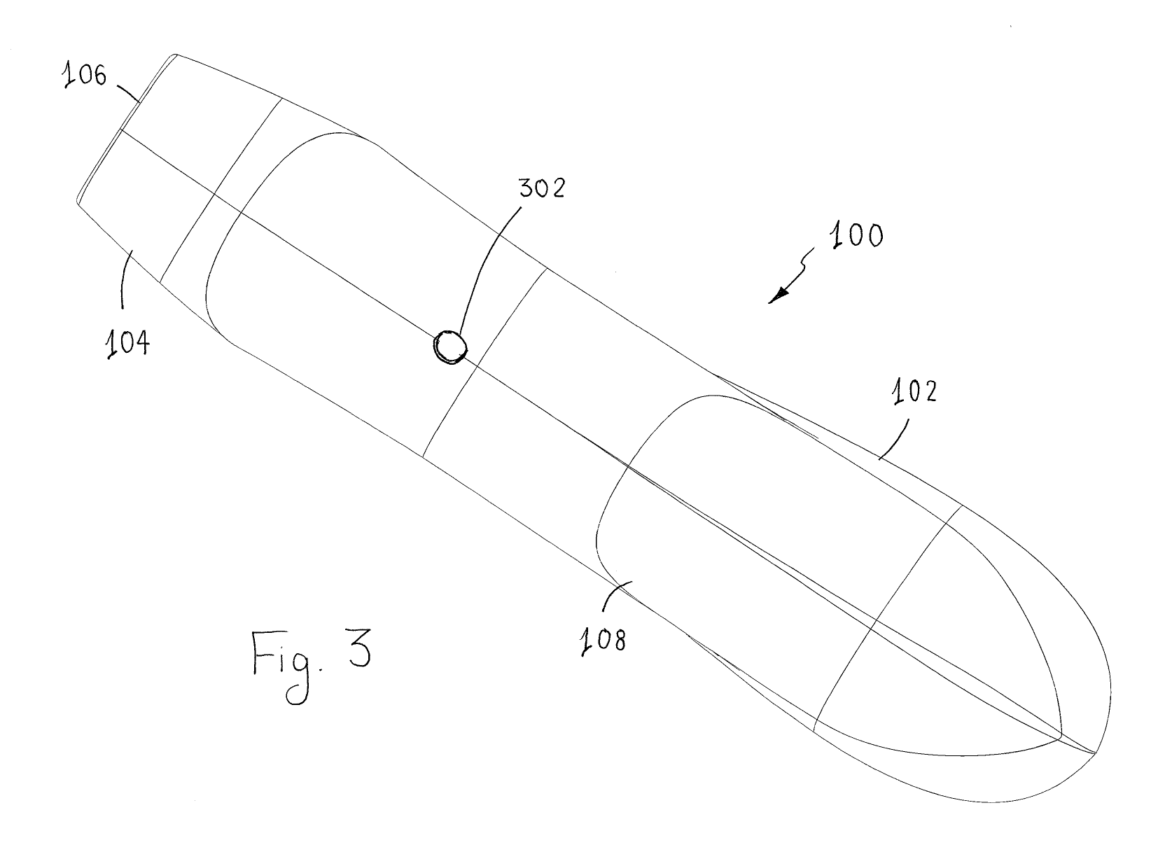

FIG. 3 illustrates a view of a lip plumping device from a different perspective that the perspective of FIG. 1.

In some embodiments of the present invention, bore 302 may be provided on the rounded portion 108 of body 102 of the device. The user may be instructed to hold a finger over bore 108, and remove the finger from the bore if experiencing unpleasant or annoying vacuum forces on the lips. In some embodiments of the invention bore 302 may be linked to pressure relief valve 208 (see FIG. 2).

In some embodiments of the device, bore 302 may be designed to be left unblocked while pressure relief valve 208 (see FIG. 2) would be designed to allow air to break into the device when a threshold negative vacuum pressure has been reached, facilitating a quick release of the lip plumping device from the lips of the user.

The user may hold aperture 106 Of the vacuum applicator 104 (see FIG. 1) to her or his lip 104, such that the lip area where lip plumping is desired is properly covered. The lip plumping device may be configured to apply vacuum in a continuous or intermittent manner. The user may move the vacuum applicator 103 across the lip or lips, so as to achieve full coverage of the lips (if the aperture of the device does not fully cover the lip or lips).

Lip surface 107 of vacuum applicator 104 (see FIG. 1) may be covered with or otherwise introduce exfoliation material. Vacuum negative pressure applied through aperture 106 enhances the attachment of the vacuum applicator 104 as well as the lip surface 107 onto the lip or lips of the user so as to apply the exfoliation material on the lip or lips. The exfoliation material is designed to gently remove an outermost layer of skin, promoting the growth of new healthy and younger cells and emphasizing the lip lines. The exfoliation materials, area of the surface on which the exfoliation material is provided and textures of that surface, as well as other parameters may vary.

The user may hold the vacuum applicator 104 against her or his lip or lips and rub it against the lip or lips, or move it along the lip or lips. While doing so negative vacuum pressure is applied by aperture 106 on the lip or lips and lip surface 107 introduces exfoliating material onto that lip or lips, enhancing plumping.

In an alternative embodiment of the lip plumping device, lip surface 107 of vacuum applicator 104 (see FIG. 1) may include nozzles 105, through which exfoliating material or cosmetic material may be introduced from an inside container (not shown in the figures) onto the lip or lips of the user.

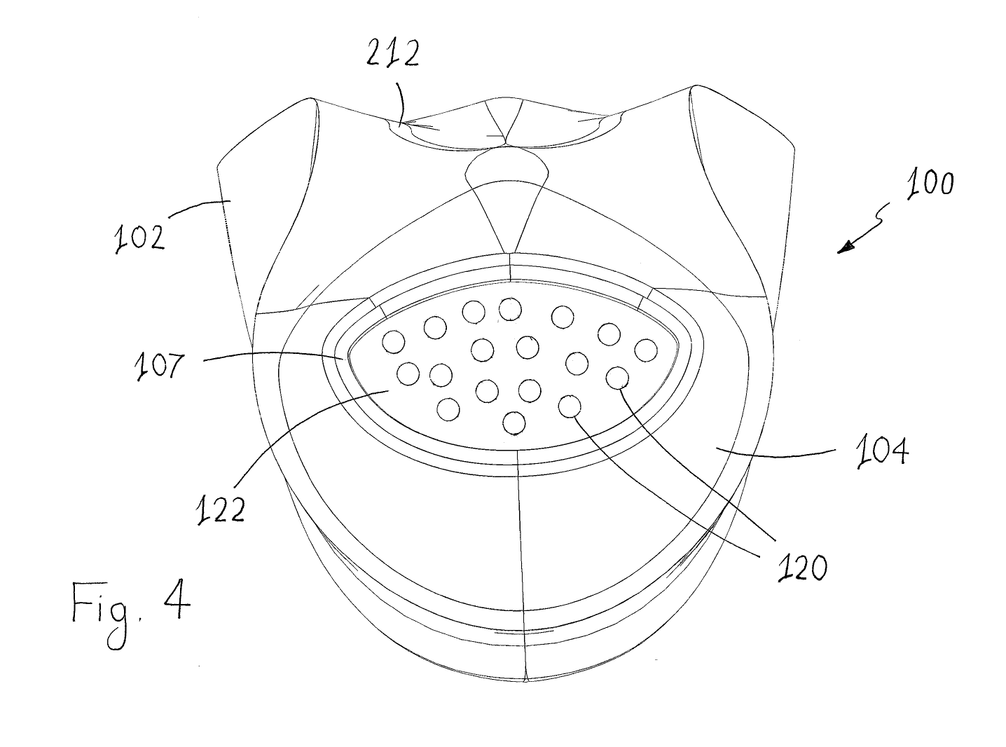

FIG. 4 illustrates the front end of vacuum applicator 104 a lip plumping device 100, according to another embodiment of the present invention. Vacuum applicator 104 in this embodiment includes a plurality of nozzles 120, which are embedded in a front surface 122 of vacuum applicator 104. Vacuum forces are applied by the vacuum pump through nozzles 120. This arrangement greatly reduces the volume of lip flesh that may be sucked into the opening of the vacuum applicator when a vacuum force is applied on the lip or lips of the user.

Front surface 122 may be, in some embodiments, covered with exfoliation material (e.g. abrasive material). This arrangement minimizes the physical separation between areas directly affected by vacuum (through nozzles 120) and areas directly affected by exfoliating material.

While certain features of the invention have been illustrated and described herein, many modifications, substitutions, changes, and equivalents will now occur to those of ordinary skill in the art. It is, therefore, to be understood that the appended descriptions are intended to cover all such modifications and changes as fall within the true spirit of the invention.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A lip plumping device comprising:
a vacuum applicator configured to fully or partially cover and apply vacuum to a lip or lips of a user; and
a controller for controlling operation of the vacuum applicator.

2. The device of claim 1, comprising an electrical vacuum pump for generating the vacuum.

3. The device of claim 2, wherein the controller is configured to sense a current or power consumption of the vacuum pump and to disconnect or reduce the power of the pump when a vacuum level generated by the pump exceeds a safety threshold.

4. The device of claim 1, comprising a bore configured to allow holding a finger over the bore to maintain operation of the vacuum applicator and releasing the vacuum by removing the finger from the bore.

5. The device of claim 1, further comprising a surface covered with exfoliating material for applying on the lip or lips of the user.

6. The device of claim 1, further configured to apply a cosmetic material on the lip or lips of the user.

7. The device as claimed in claim 6, wherein the vacuum applicator comprises a plurality of nozzles configured to introduce the cosmetic material.

8. The device of claim 6, wherein the cosmetic material is selected from the group of cosmetic materials consisting of a therapeutic cream and lip gloss.

9. The device of claim 1, further comprising a power source.

10. The device of claim 1, wherein the vacuum applicator comprises an elongated aperture through which the vacuum is applied on the lip or lips.

11. The device of claim 10, wherein the aperture is oval or circular.

12. The device of claim 1, wherein the vacuum applicator comprises a plurality of nozzles through which the vacuum is applied on the lip or lips.

13. The device of claim 1, further comprising a pressure relief valve.

14. A method for lip plumping, the method comprising:
fully or partially covering a lip or lips of a user by a vacuum applicator and applying vacuum to a lip or lips of a user using the vacuum applicator; and
controlling operation of the vacuum applicator using a control unit.

15. The method of claim 14, further comprising generating the vacuum by an electrical vacuum pump.

16. The method of claim 14, further comprising holding a finger over a bore to maintain operation of the vacuum applicator and releasing the vacuum by removing the finger from the bore.

17. The method of claim 14, further comprising concurrently exfoliating the lip or lips using exfoliating material covering a surface of the vacuum applicator.

18. The method of claim 14, further comprising applying a cosmetic material on the lip or lips of the user using the device.

19. The method of claim 18, wherein the cosmetic material is selected from the group of cosmetic materials consisting of a therapeutic cream and lip gloss.
